(19) United States
(12) Patent Application Publication
(10) Pub. No.: US 2002/0056053 A1
(43) Pub. Date: May 9, 2002

(54) System and method for handling web failures

(76) Inventors: Ben Vine, Raanana (IL); Uri Mozer, Tel Aviv (IL)

Correspondence Address: John L. Welsh, Esq., WELSH & FLAXMAN, Suite 112, 2341 Jefferson David Highway, Arlington, VA, 22202, US

(21) Appl. No.: 09/983,694

(22) Filed: Oct. 25, 2001

Related U.S. Application Data
(60) Provisional application No. 60/243,284, filed on Oct. 26, 2000.

(51) Int. Cl. G06F 11/00

(52) U.S. Cl. 714/4

(57) ABSTRACT

Systems, methods or processes, and computer or machine readable articles, are disclosed, that utilize idle time associated with web failures, by catching these web failures and convert the errors associated therewith into usable web space. This is accomplished as web failures, including specific types of web failures, are detected in the connection between client and server, and upon detection of this web failure, the client browser is redirected to a dynamic and customized web page containing content directly relevant to the topics the user was seeking.

### CROSS REFERENCES TO RELATED APPLICATIONS

This application claims priority from and is related to commonly owned U.S. Provisional Patent Application Ser. No. 60/243,284, entitled: SYSTEM AND METHOD FOR HANDLING WEB FAILURES, filed on Oct. 26, 2000, which is incorporated by reference in its entirety herein.

### TECHNICAL FIELD

The present invention is directed to web failures and in particular to apparatus and methods for detecting and customizing web failures in between the client's browser and the origin servers.

### BACKGROUND

Computer users are required to employ browsing software, or browsers, such as Netscape Navigator®) (Netscape Communications, Mountain View, Calif.) or Internet Explorer® (Microsoft, Inc., Redmond, Wash.), when they desire to access information or “surf” the World Wide Web (WWW) via the Internet. The information is typically provided on web pages, contained within web sites, downloaded from web servers where they are stored.

These web sites and web pages typically have addresses in hypertext transfer protocols (HTTP), these addresses are known as Uniform Resource Locators (URLs). For example, the ABC Company, may have a URL of http://www.abc.com. When a user wishes to view web pages contained in web sites on a network, such as the Internet, the user types in the domain name and the browser locates the corresponding site. Should the site not be available due to a web failure, the browser typically provides a failure message that the site can not be viewed.

Web failures typically occur from five to fifteen percent of the time a user is browsing or “surfing” the World Wide Web. Some of these errors may not occur again if the user or “surfer” starts the process again. Web failures fall into various classes.

One class of web failures occurs as the user attempts to go to an existing web server for a target web page. These web failures include Transmission Control Protocol (TCP) and HTTP errors. TCP errors include errors caused by timeouts and connection resets. For example, a user may attempt to go to a target web page with the proper HTTP address entered, but the connection will time out or be broken prior to the target web page being accessed. Hyper Text transfer Protocol (HTTP) errors may occur, for example, when a web page is not found, typically because it does not exist, or the web server has an internal error(s).

Another class of errors, known as Domain Name System (DNS) errors, occurs when a target web server is sought, but does not exist. These Domain Name System (DNS) errors, typically occur as a result of an incorrect host name having been requested during browsing.

FIG. 1 illustrates a typical browsing scenario. Here, a web failure, and specifically, an HTTP error, was encountered when the user requested a non existent URL 20 (shown in broken lines for emphasis only) and received a failure message 21 (shown in broken lines for emphasis only), noting that the requested object could not be found.

### SUMMARY

The present invention improves on the contemporary art by providing systems, methods or processes, and computer or machine readable articles for utilizing this idle time, by catching web failures and converting the errors into usable web space. This is accomplished as web failures, including specific types of web failures, are detected in the connection between client and server, and upon detection of this web failure, the client browser is redirected to a dynamic and customized web page containing content directly relevant to the topics the user was seeking.

In one embodiment of the invention, there is a method for providing customized and targeted content from web failures, resulting from attempts to contact target web servers. This method comprises monitoring, in a service provider infrastructure, at least one connection between a client and a web server, detecting a web failure in the at least one connection between a client and a web server, and responding to the detected web failure by transmitting at least one data object, to the client. This transmitted data object is typically either a predetermined data object or a redirection data object.

In another embodiment of the invention, there is an apparatus, typically a server, or providing customized and targeted content from web failures, resulting from attempts to contact target web servers, comprising. A redirector module and at least one processor. The processor(s) is programmed to monitor, in a service provider infrastructure, at least one connection between a client and a web server, detect a web failure in the at least one connection between a client and a web server; and respond to the detected web failure by transmitting at least one data object, to the client.

Another embodiment of the invention is directed to a programmable storage device (for example, computer disc, compact disc, etc.) readable by a machine, tangibly embodying a program of instructions executable by a machine to perform method steps for providing customized and targeted content from web failures, resulting from attempts to contact target web servers, the method steps selectively executed during the time when the program of instructions is executed on the machine. These method steps comprise, monitoring, in a service provider infrastructure, at least one connection between a client and a web server, detecting a web failure in the at least one connection between a client and a web server, and responding to the detected web failure by transmitting at least one data object the client.

### BRIEF DESCRIPTION OF THE DRAWINGS

Attention is now directed to the attached drawings, wherein like reference numeral or characters indicate corresponding or like components. In the drawings:

FIG. 1 is a screen shot of a typical browser page for a typical message resulting from a web failure;

FIG. 2 is a schematic diagram of the present invention;

FIG. 3 is a screen shot of a browser page resulting from a web failure in accordance with the present invention;

FIG. 4 is a Flow Diagram of a method in accordance with an embodiment of the present invention;

FIGS. 5a is a schematic diagram of the redirector module (PSIGO) and the issuance of a redirection packet therefrom; and

FIG. 5b is a detailed portion of the flow diagram of FIG. 4.

### DETAILED DESCRIPTION OF THE DRAWINGS

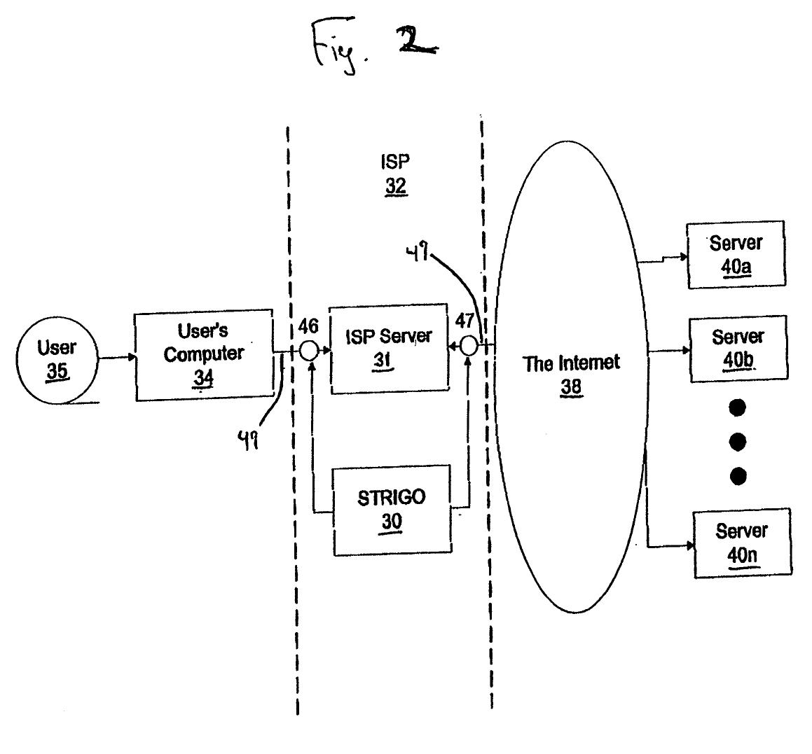

FIG. 2 shows the apparatus 30 of the present invention in an exemplary operation. This apparatus is typically a server that is auxiliary to the connectivity or Internet Service Provider (ISP) server 31 (Proxy Server, router, DNS Server etc.) typically in the Internet Service Provider's (ISP's) 32 infrastructure. The apparatus 30 (know as server 30 hereinafter, and referred to here as a “STRIGO” server), typically includes at least one processor (and typically plural processors, microprocessors, etc.), storage media, etc., and is intermediate a workstation 34, typically a personal computer (PC) of a user 35 and a network 38, typically the Internet. The user 35 can access various servers 40a, 40b, 40n, via the Internet 38. The ISP's connectivity server 31 connects the user's workstation 34 to the Internet 38. The server (STRIGO server) 30 of the present invention is for example, connected at nodes 46, 47, along the connection 49, typically a Fast Ethernet, between the user 35 and ISP's connectivity server 31, and the ISP's connectivity server 31 and the Internet 38, respectively.

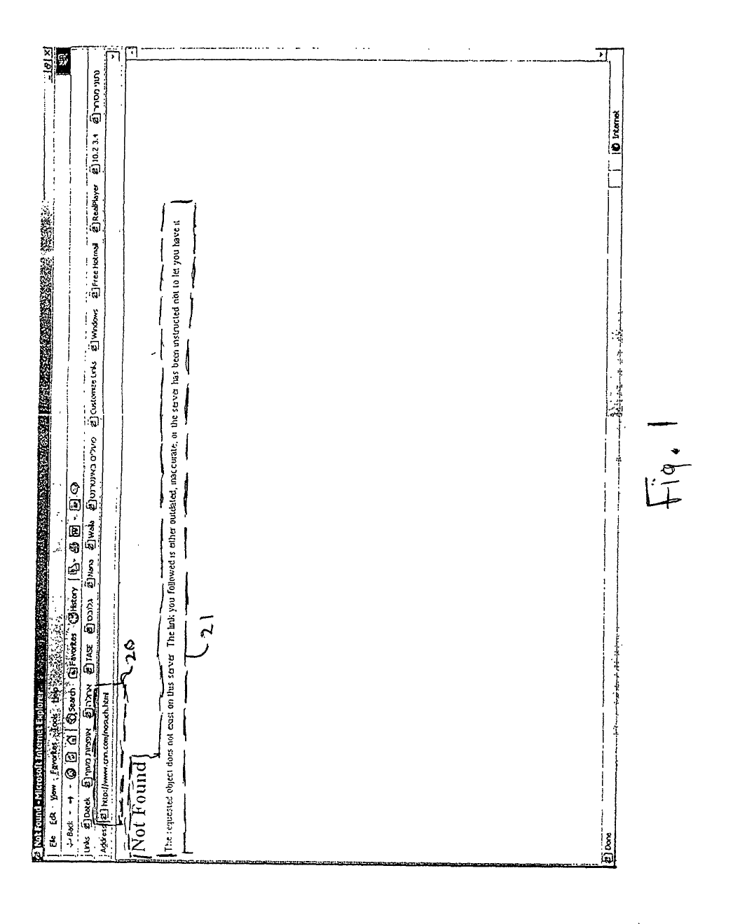

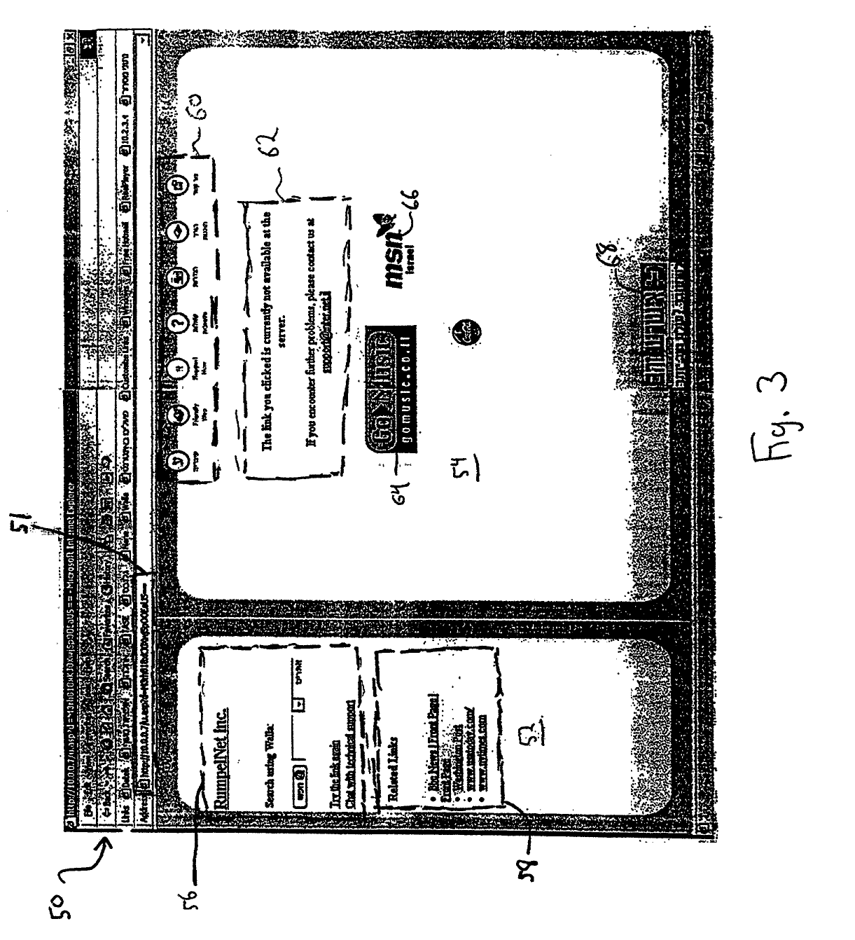

As a result of the STRIGO server 30 typically connected at the nodes 46, 47, the connection 49 can be monitored. Should the monitoring detect a web failure, the STRIGO server 30 sends a data object(s), such as a predetermined data object or redirection data object, to the workstation 34 (for example, the computer) of the user 35, typically through the infrastructure of the ISP, instead of the conventional failure message, such as that described above and shown in FIG. 1. Also, at the same time or contemporaneous therewith, a predetermined connection signal is sent to the original or target (typically, the intended) server, for example, any of servers 40a, 40b, 40n (in the case of HTTP and TCP errors, as detailed below). The predetermined or redirection data object redirects the user 35 to an alternate dynamic error message that appears on the screen of the workstation 34, and is shown as a browser page 50 in the screen shot of FIG. 3.

Predetermined data objects include, for example, an address(es) of a predetermined server, with DNS errors, and in the case of HTTP and TCP errors, a predetermined Hypertext Mark-Up Language (HTML) error page. Redirection data objects include, for example, an HTTP redirection containing null content or customized short content (such as containing a java script), a predetermined page, or in the case of a DNS error, the address(es) of a predetermined server.

The screen shot of FIG. 3 is exemplary of any screen shot of a data object as typically stored in the STRIGO server 30, and has its own URL 51. In this screen shot, various portions are in broken lines. These broken lines and or boxes formed thereof, are for emphasis only and are not part of what is actually seen. The browser page 50 in the screen shot is broken into sections 52, 54. One section 52 includes a search engine 56 with other related links 58 dynamically, while the other section 54 includes links to the ISP services along bar 60, language configurable error message 62, and some banners related to the content the user 35 is searching 64, 66. Also note the ISP logo at the bottom of the page 68.

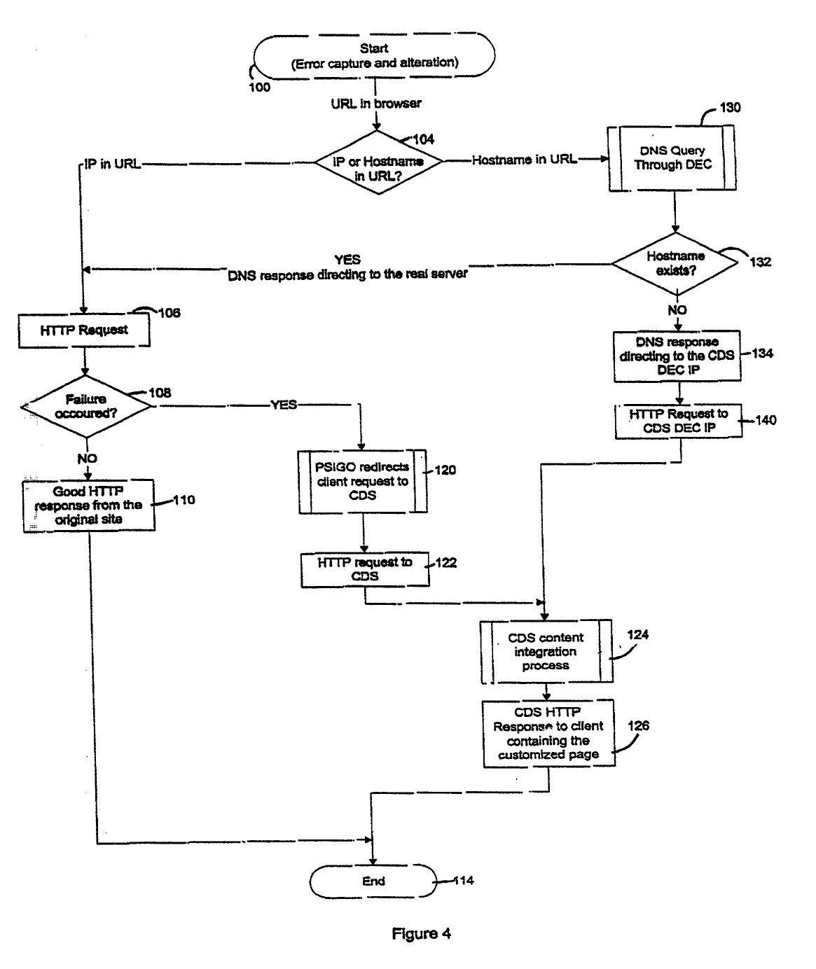

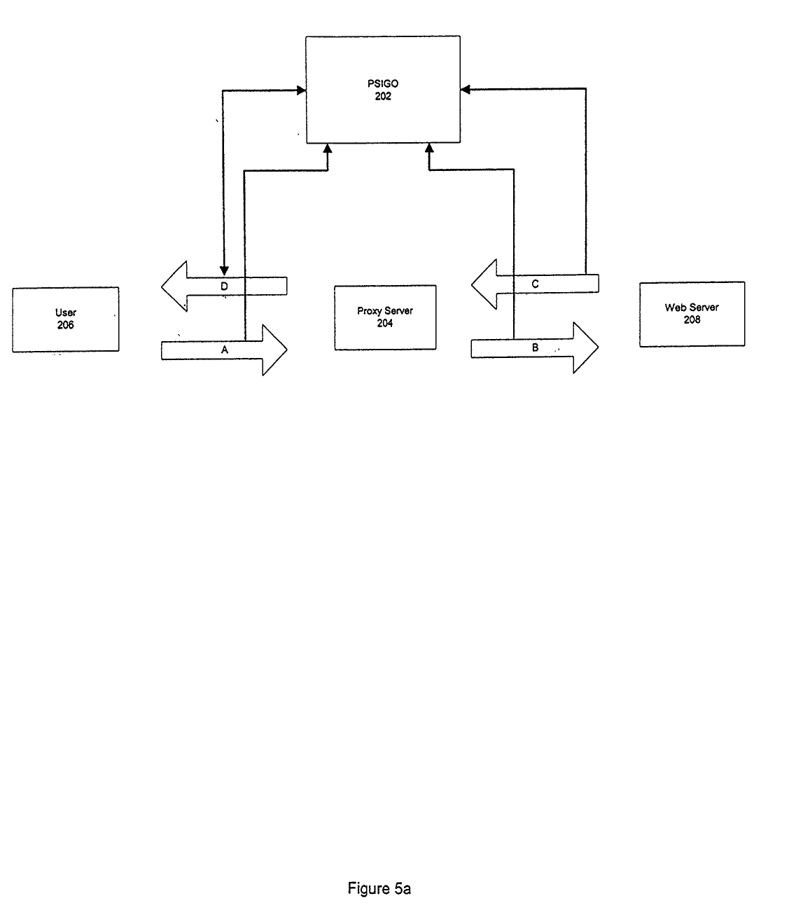

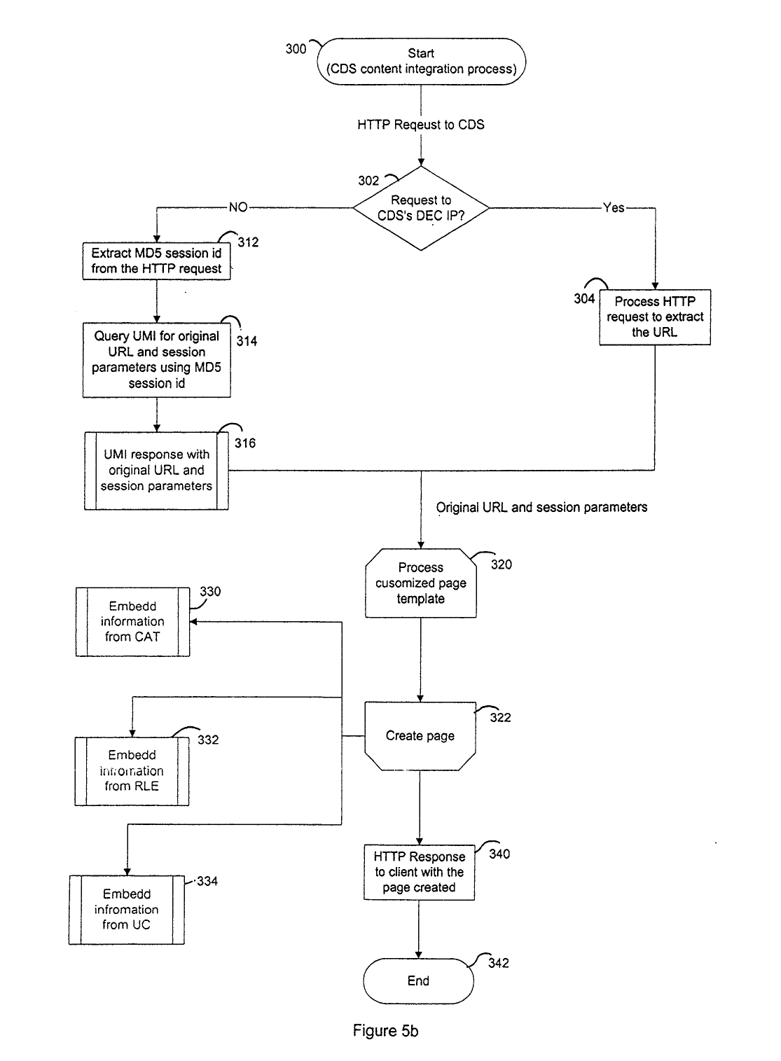

FIG. 4 details a flow diagram, from which web failures will be detected and customized content will be sent to the user, such as browser pages similar to that of browser page 50 of FIG. 3. Web failures are typically from the following categories: DNS Errors, HTTP Errors and TCP Errors, and based on their category will be handled differently by the present invention in the server 30, in accordance with the process detailed in FIG. 4. Also, where indicated, handling will be in accordance with the processes detailed in FIGS. 5a and 5b.

The process of the present invention, as detailed in FIG. 4, begins as the user 35 at block 100, enters the desired URL into his browser. The browser then checks the URL at block 104 and if the URL contains an Internet Protocol (IP) address, than the browser issues an HTTP request at block 106, to the original server IP address (40a, 40b to 40n). If at block 104, the URL contains a hostname, then the browser issues a DNS query at block 130 to the ISP DNS server (containing the STRIGO DNS Error Corrector (DEC) extension). The DNS server runs the query and then the DEC checks, at block 132, if the DNS has a valid IP address for the requested server.

If there is a valid IP address for the server, then the DNS server replies it to the browser and the browser, at block 106 issues an HTTP request to the server (40a, 40b to 40n). If a valid IP address is not known for the target server, then the DEC replies at block 134 to the browser's DNS query with an IP address of the Content Delivery Server (CDS). The browser, at block 140, issues an HTTP request to the CDS. When the browser issues an HTTP request at block 106, a redirector module (referred to herein as “PSIGO”), embedded in hardware, software or combinations thereof, in the server 30 (FIG. 2), is monitoring this requests and replies. If a failure is detected, at block 108, this redirector module issues a redirection packet for the browser, at block 120. This issuance of a redirection packet is described in FIG. 5a and in additional detail below.

As a result of receiving the redirection packet, the browser (of the user 35) issues a new HTTP request at block 122, that is directed to the CDS. When the CDS, at block 124, detailed in FIG. 5b below, receives an HTTP request (from the user), it integrates content to a customized page, and then, responds to the browser at block 126 with a browser page similar to the browser page 50 shown in FIG. 3.

Turning back to block 108, if an error was not detected, then the original server (40a, 40b to 40n) responds to the user, at block 110. In this response, the user is sent the desired target web page.

FIG. 5a details the schematic diagram, from which the redirector module (PSIGO) identifies a web failure, and redirects it to the CDS, as detailed in block 120 of FIG. 4. The Environment in which the PSIGO 202 is functioning is such that it surrounds an ISP Proxy server 204, similar to ISP server 31. This proxy server 204 functions as a mediator between the ISP's user or client 206, who is similar to the user or client 35 in FIG. 2, and the web server 208, similar to web server 40a, 40b to 40n in FIG. 2.

In a typical HTTP session, the user 206 sends an HTTP request through line A (lines A-D indicated by arrows labeled correspondingly) to the web server 208, that is received by the proxy server 204. The proxy server 204 then issues an equivalent HTTP request to the web server 208 through line B. The web server 208 receives the request and issues an HTTP response through line C to the proxy server 204. The proxy server 204 then issues and equivalent HTTP response through line D to the user 206. The PSIGO 202 continuously monitors lines A, B, C and D, tracking activity in these lines in order to detect web failures.

An HTTP web failure will be identified by content passing through line C, as the web server 208 responds with an error code in the HTTP parameters. The PSIGO 202 identifies the error code and matches the HTTP response with the equivalent HTTP request from line A. The PSIGO 202 then injects a redirection packet to line D, redirecting the User 206 to the CDS (block 122 in FIG. 4). Activity continues in accordance with block 122 in FIG. 4 as detailed above.

A TCP web failure will be identified by content passing through lines C and D, as the web server 208 and/or the proxy server 204 will cause a TCP reset or a TCP timeout. The PSIGO 202 identifies this reset or timeout situation, matches the TCP packets needed for redirecting the user 206 to the CDS (block 122 in FIG. 4) and injects them through line D. Activity continues in accordance with block 122 in FIG. 4 as detailed above.

FIG. 5b details an example process, by a flow diagram, from which the customized content page, similar to page 50 of the screen shot of FIG. 3, will be produced. The customized content page provides content matching to the intended URL, for which the error occurred, and other session parameters, and is integrated with other external content sources. The process commences at block 124 of FIG. 4, relabeled as start block 300, where and HTTP request is sent to the CDS.

This request is originated from the user's 35 browser due to a PSIGO redirection or a DEC DNS reply. The system checks, at block 302, if the request is to the CDS's assigned DEC IP address, in which case the system at block 304, processes the HTTP request to extract the URL and other session parameters. If the request is to the CDS's regular IP, than the PSIGO is the source of the redirection, and at block 312, the system extracts the MD5 session identifier (ID) from the HTTP request. The MD5 is defined in R. Rivest, “The MD5 Message-Digest Algorithm”, Network Working Group, Request For Comments (RFC) 1321, April 1992, incorporated by reference herein (referred to hereinafter as “RFC 1321”). The CDS then queries the URL-MD5-IP Database (UMI) for the original URL and session parameters using the MD5 session ID, at block 314. At block 316, the UMI responds with the URL and session parameters.

The system, with the URL and session parameters starts processing the content template at block 320. The template states the exact blocks to be integrated to the page, and according to this, the system, at block 322 calls for the information from blocks 330, 332 and 334. At block 330, the system embeds information from the Categorization (CAT) module, such as by the Developer tool kit from RuleSpace, Inc., Portland, Oreg. 97205, integrating a category parameter into the page. At block 332, the system embeds related links from the Related Links Exchange (RLE), such as the Alexa Anywhere Service, from Alexa, Inc., San Francisco, Calif. 94129-0141, and at block 334, the system embeds additional user information from the User Classification (UC) module. This UC module queries the ISP's user database. After all data form blocks 330, 332 and 334 has been integrated to create a web page, the CDS sends an HTTP response, at block 340, with the customized page created, which ends the content integration process at block 342. The process then returns to block 126 of FIG. 4 as detailed above.

The process detailed above, all or portions thereof, can be embodied in programmable storage devices readable by a machine or the like, or other computer-usable storage medium, including magnetic, optical or semiconductor storage, or other source of electronic signals.

The processes (methods) and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for providing customized and targeted content from web failures, resulting from attempts to contact target web servers, comprising:
monitoring, in a service provider infrastructure, at least one connection between a client and a web server;
detecting a web failure in said at least one connection between a client and a web server; and
responding to said detected web failure by transmitting at least one data object, to said client.

2. The method of claim 1, wherein said at least one connection includes two connections between said client and said web server.

3. The method of claim 2, wherein said two connections include nodes.

4. The method of claim 1, wherein said detecting a web failure includes detecting a web failure by detecting at least one of the group comprising: Hypertext Transfer Protocol (HTTP) errors, Domain Name Server (DNS) errors and Transmission Control Protocol (TCP) errors.

5. The method of claim 1, wherein said data object includes at least one predetermined data object.

6. The method of claim 1, wherein said data object includes at least one redirection data object.

7. The method of claim 1 wherein said transmitting at least one data object includes issuing at least one redirection packet for the browser of said client.

8. The method of claim 1, wherein said responding to said detected web failure additionally includes:
sending a predetermined connection signal to said target web server.

9. An apparatus for providing customized and targeted content from web failures, resulting from attempts to contact target web servers, comprising:
a redirector module; and
at least one processor programmed to:
monitor, in a service provider infrastructure, at least one connection between a client and a web server;
detect a web failure in said at least one connection between a client and a web server; and
respond to said detected web failure by transmitting at least one data object, to said client.

10. The apparatus of claim 9, wherein said at least one processor is programmed to monitor at least two connections between a client and a web server.

11. The apparatus of claim 9, wherein said at least one processor is additionally programmed to:
detect said web failure by detecting at least one of the group comprising: Hypertext Transfer Protocol (HTTP) errors, Domain Name Server (DNS) errors and Transmission Control Protocol (TCP) errors.

12. The apparatus of claim 9, wherein said at least one processor is additionally programmed to: transmit said data object by transmitting at least predetermined data object.

13. The apparatus of claim 9, wherein said at least one processor is additionally programmed to: transmit said data object by transmitting at least one redirection data object.

14. The apparatus of claim 9, wherein said at least one processor is additionally programmed to: respond to said detected web failure by issuing at least one redirection packet for the browser of said client.

15. The apparatus of claim 9, wherein said at least one processor is additionally programmed to: responding to said detected web failure additionally by sending a predetermined connection signal to the intended web server.

16. A programmable storage device readable by a machine, tangibly embodying a program of instructions executable by a machine to perform method steps for providing customized and targeted content from web failures, resulting from attempts to contact target web servers, said method steps selectively executed during the time when said program of instructions is executed on said machine, comprising:
monitoring, in a service provider infrastructure, at least one connection between a client and a web server;
detecting a web failure in said at least one connection between a client and a web server;
responding to said detected web failure by transmitting at least one data object said client.
